(19) United States
(12) Patent Application Publication
(10) Pub. No.: US 2025/0183576 A1
(43) Pub. Date: Jun. 5, 2025

(54) CONNECTOR SYSTEM AND CONNECTOR

(71) Applicant: SUMITOMO ELECTRIC INDUSTRIES, LTD., Osaka (JP)

(72) Inventors: Masaki SUZUKI, Osaka-shi (JP); Yasunori ASANO, Osaka-shi (JP)

(73) Assignee: SUMITOMO ELECTRIC INDUSTRIES, LTD., Osaka (JP)

(21) Appl. No.: 18/953,546

(22) Filed: Nov. 20, 2024

(30) Foreign Application Priority Data
Nov. 30, 2023 (JP) 2023-203070

(51) Int. Cl. H01R 13/24; H01R 13/50

(52) U.S. Cl. CPC H01R 13/2471; H01R 13/50

(57) ABSTRACT

A connector system includes a first connector including a first holding body having a first tip end surface, and a first conductor held by the first holding body and a second connector including a second holding body having a second tip end surface facing the first tip end surface, and a second conductor held by the second holding body. The first conductor includes a first tip end portion having a first connection surface exposed at the first tip end surface, and a first body portion located on a side of the first tip end portion opposite to a side where the second connector is present. The second conductor has a second connection surface exposed at the second tip end surface and facing the first connection surface.

### CROSS REFERENCE TO RELATED APPLICATIONS

This application claims the benefit of priority based on Japanese Patent Application No. 2023-203070, filed on Nov. 30, 2023, and the entire contents of the Japanese patent application are incorporated herein by reference.

### TECHNICAL FIELD

The present disclosure relates to a connector system and a connector.

### BACKGROUND ART

JP2020-126823A discloses a connector system includes a first connector having a first holding body and a first conductor held by the first holding body, and a second connector having a second holding body and a second conductor held by the second holding body. In this connector system, when the first holding body is connected to the second holding body, the first conductor is electrically connected to the second conductor.

### SUMMARY OF THE INVENTION

A connector system of the present disclosure includes a first connector and a second connector. The first connector includes a first holding body having a first tip end surface, and a first conductor held by the first holding body. The second connector includes a second holding body having a second tip end surface configured to face the first tip end surface, and a second conductor held by the second holding body. The first conductor includes a first tip end portion having a first connection surface exposed at the first tip end surface, and a first body portion located on a side of the first tip end portion opposite to a side where the second connector is present. The second conductor has a second connection surface exposed at the second tip end surface and configuring to face the first connection surface. A width of the first connection surface viewed in a direction intersecting the first tip end surface is larger than a width of the second connection surface viewed in a direction intersecting the second tip end surface. A dielectric constant of a first region of the first holding body, the first region surrounding the first tip end portion, is smaller than a dielectric constant of a second region of the second holding body, the second region surrounding the second conductor.

### BRIEF DESCRIPTION OF THE DRAWINGS

FIG. 1 is a cross-sectional view of a connector system according to an embodiment.

FIG. 2 is a front view of a first connector shown in FIG. 1.

FIG. 3 is a front view of a second connector shown in FIG. 1.

FIG. 4 is a partial enlarged view of FIG. 1.

FIG. 5 is a cross-sectional view of a connector system according to a first modification.

FIG. 6 is a cross-sectional view of a connector system according to a second modification.

### DETAILED DESCRIPTION

In the connector system described in JP 2020-126823A, the position of the first conductor and the position of the second conductor may be misaligned due to variations in the dimensions of the first holding body or the second holding body. In this case, the contact area between the first conductor and the second conductor is reduced, and as a result, it may be difficult to ensure the conduction between the first conductor and the second conductor. When the width of the first conductor or the second conductor is increased, even if the position of the first conductor and the position of the second conductor are misaligned from each other, the contact area between the first conductor and the second conductor can be ensured, and the conduction between the first conductor and the second conductor can be ensured. However, when the width of the first conductor or the second conductor is increased, impedance around the first conductor and the second conductor is likely to be disturbed, and as a result, communication performance may be degraded.

According to the present disclosure, a connector system and a connector capable of preventing a deterioration in communication performance while ensuring conduction.

### DESCRIPTION OF EMBODIMENTS OF PRESENT DISCLOSURE

First, the contents of embodiments of the present disclosure will be listed and explained.

[1] A connector system of the present disclosure includes a first connector and a second connector. The first connector includes a first holding body having a first tip end surface, and a first conductor held by the first holding body. The second connector includes a second holding body having a second tip end surface configured to face the first tip end surface, and a second conductor held by the second holding body. The first conductor includes a first tip end portion having a first connection surface exposed at the first tip end surface, and a first body portion located on a side of the first tip end portion opposite to a side where the second connector is present. The second conductor has a second connection surface exposed at the second tip end surface and configuring to face the first connection surface. A width of the first connection surface viewed in a direction intersecting the first tip end surface is larger than a width of the second connection surface viewed in a direction intersecting the second tip end surface. A dielectric constant of a first region of the first holding body, the first region surrounding the first tip end portion, is smaller than a dielectric constant of a second region of the second holding body, the second region surrounding the second conductor.

In the connector system according to the above [1], the width of the first connection surface is larger than the width of the second connection surface. Thus, even if the position of the first conductor and the position of the second conductor are misaligned, the contact area between the first conductor and the second conductor is ensured, and as a result, the conduction between the first conductor and the second conductor is ensured. In addition, the dielectric constant of the first region of the first holding body, the first region surrounding the first tip end portion, is smaller than the dielectric constant of the second region of the second holding body, the second region surrounding the second conductor. Thus, impedance disturbance around the first tip end portion and the second conductor is prevented, and thus a deterioration in communication performance is prevented. According to the connector system, it is possible to prevent a deterioration in communication performance while ensuring conduction.

[2] In the connector system described in the above [1], the width of the first connection surface may be larger than a width of the first body portion viewed in the direction intersecting the first tip end surface, and the dielectric constant of the first region may be smaller than a dielectric constant of a third region of the first holding body, the third region surrounding the first body portion. Thus, the contact area between the first conductor and the second conductor is ensured and the impedance disturbance around the first conductor is prevented.

[3] In the connector system described in the above [2], the first region may contain air, and each of the second region and the third region may contain a resin. Thus, the impedance disturbance around the first conductor and the second conductor is prevented in a preferred manner.

[4] In the connector system described in any one of the above [1] to [3], the first tip end portion may be formed to be integrated with the first body portion. Thus, the number of components of the connector system is reduced.

[5] In the connector system described in any one of the above [1] to [3], the first tip end portion may be formed to be separated from the first body portion. Thus, the design flexibility of each of the first tip end portion and the first body portion is improved.

[6] In the connector system described in any one of the above [1] to [5], the first holding body may have a plurality of first insertion holes opening at the first tip end surface, the first conductor may be each of a plurality of electrical wires of a flexible flat cable, and each of the plurality of electrical wires may be inserted into a corresponding one of the plurality of first insertion holes. Thus, the electrical connection of the electric wires of the flexible flat cable is ensured, and the deterioration of the communication performance of the flexible flat cable is prevented.

[7] In the connector system described in the above [6], the second holding body may have a plurality of second insertion holes opening at the second tip end surface, the second conductor may be each of a plurality of conductors, and each of the plurality of conductors may be inserted into a corresponding one of the plurality of second insertion holes. Thus, the electrical connection of the electric wires of the flexible flat cable is ensured, and the deterioration of the communication performance of the flexible flat cable is prevented.

[8] A connector of the present disclosure includes a holding body having a tip end surface and a rear end surface opposite to the tip end surface, and a conductor held by the holding body. The conductor includes a tip end portion having a connection surface exposed at the tip end surface, and a body portion located on a side of the tip end portion closer to the rear end surface. A width of the connection surface viewed in a direction intersecting the tip end surface is larger than a width of the body portion viewed in the direction intersecting the tip end surface. A dielectric constant of a region of the holding body, the region surrounding the tip end portion, is smaller than a dielectric constant of another region of the holding body, the other region surrounding the body portion.

In the connector described in the above [8], the width of the connection surface of the tip end portion is larger than the width of the body portion. Thus, even if the position of the conductor of the above connector and the position of a conductor of a mating connector are misaligned, the contact area between the conductor of the above connector and the conductor of the mating connector is ensured, and as a result, the conduction between the conductor of the above connector and the conductor of the mating connector is ensured. In addition, the dielectric constant of the region of the holding body, the region surrounding the tip end portion, is smaller than the dielectric constant of the region of the holding body, the other region surrounding the body portion. Thus, impedance disturbance around the conductor is prevented, and as a result, a deterioration in communication performance is prevented. According to the connector, it is possible to prevent the deterioration of communication performance while ensuring conduction.

### DETAILS OF EMBODIMENTS OF PRESENT DISCLOSURE

Specific examples of the connector system of the present disclosure will be described below with reference to the drawings. The present disclosure is not limited to these examples, but is defined by the scope of the claims, and is intended to include all modifications within the meaning and scope equivalent to the scope of the claims. In the description of the drawings, the same elements are denoted by the same reference numerals, and redundant description will be omitted.

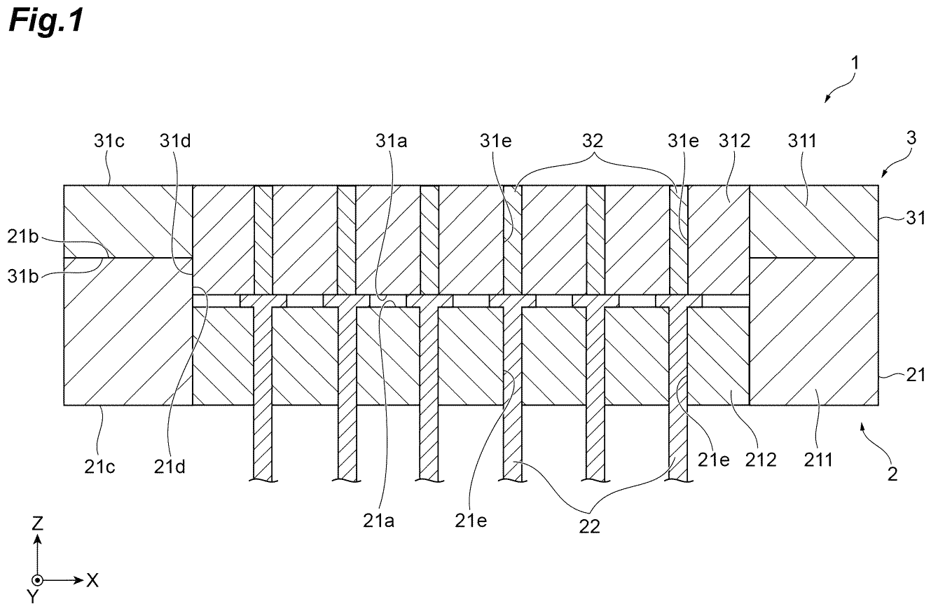

FIG. 1 is a cross-sectional view of a connector system of an embodiment. As shown in FIG. 1, a connector system 1 includes a first connector 2 and a second connector 3. First connector 2 is, for example, a plug connector. Second connector 3 is, for example, a receptor connector.

First connector 2 includes a first holding body 21 and a plurality of first conductors 22. First holding body 21 includes a first housing 211 and a first ferrule 212. First housing 211 has, for example, a rectangular tubular shape. First ferrule 212 is provided inside first housing 211. First ferrule 212 includes a resin material such as liquid crystal polymer (LCP), polyphenylene sulfide (PPS), or polyetherimide (PEI).

First holding body 21 includes a tip end surface 21a (first tip end surface), a tip end surface 21b, a rear end surface 21c, a side surface 21d, and a plurality of insertion holes 21e (first insertion holes). Each of tip end surface 21a and tip end surface 21b is, for example, a flat surface intersecting the Z-axis direction. Tip end surface 21a and tip end surface 21b face to the same direction.

Tip end surface 21a is formed by first ferrule 212. Tip end surface 21a has, for example, a rectangular shape when viewed from the Z-axis direction. Tip end surface 21a is recessed from tip end surface 21b. Tip end surface 21a is located near rear end surface 21c with respect to tip end surface 21b. Tip end surface 21b is formed by first housing 211. Tip end surface 21b has, for example, a rectangular frame shape when viewed from the Z-axis direction. Tip end surface 21b surrounds tip end surface 21a when viewed from the Z-axis direction.

Rear end surface 21c is formed by first housing 211 and first ferrule 212. Rear end surface 21c is, for example, a flat surface intersecting the Z-axis direction. Rear end surface 21c faces the opposite side to tip end surface 21a and tip end surface 21b. Side surface 21d is formed by first housing 211. Side surface 21d has, for example, a cylindrical shape extending along the Z-axis direction. Side surface 21d is located on the opposite side of rear end surface 21c with respect to tip end surface 21a. Side surface 21d surrounds tip end surface 21a when viewed from the Z-axis direction. Side surface 21d faces the inside of first housing 211 when viewed from the Z-axis direction.

The plurality of insertion holes 21e are formed in first ferrule 212. Each insertion hole 21e extends along the Z-axis direction, for example. Each insertion hole 21e has, for example, a cylindrical shape. In the embodiment, each insertion hole 21e penetrates first ferrule 212. That is, each insertion hole 21e is opened at each of tip end surface 21a and rear end surface 21c.

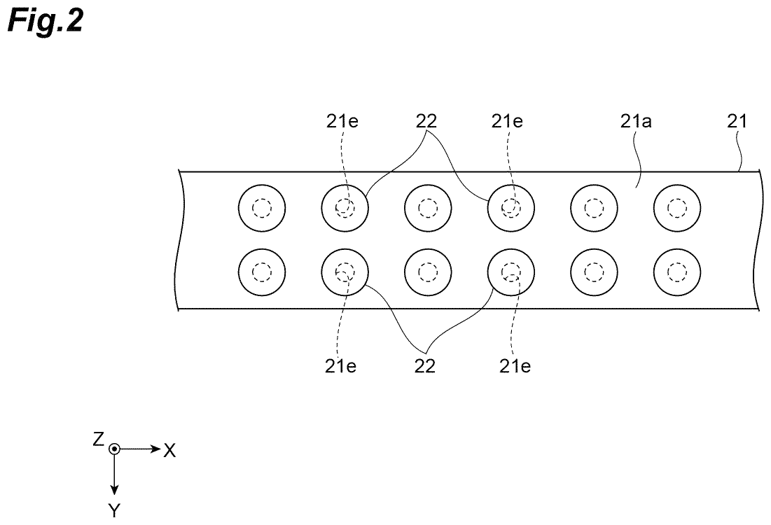

FIG. 2 is a front view of first connector 2. As shown in FIGS. 1 and 2, in the embodiment, first holding body 21 includes two rows of insertion holes 21e. Insertion holes 21e in the first row and insertion holes 21e in the second row are adjacent to each other in the Y-axis direction. Insertion holes 21e in each row are arranged along the X-axis direction.

Each first conductor 22 has, for example, a circular shape in a cross section along the XY plane. First conductor 22 is, for example, each of a plurality of electric wires of a flexible flat cable (FFC). Each first conductor 22 is inserted into each insertion hole 21e. Thus, the plurality of first conductors 22 are held by first holding body 21. The material of first conductor 22 is, for example, annealed copper or the like.

As shown in FIG. 1, second connector 3 includes a second holding body 31 and a plurality of second conductors 32. Second holding body 31 includes a second housing 311 and a second ferrule 312. Second housing 311 has, for example, a rectangular tubular shape. Second ferrule 312 is provided inside second housing 311. Second ferrule 312 includes a resin material such as liquid crystal polymer (LCP), polyphenylene sulfide (PPS), or polyetherimide (PEI).

Second holding body 31 includes a tip end surface 31a (second tip end surface), a tip end surface 31b, a rear end surface 31c, a side surface 31d, and a plurality of insertion holes 31e (second insertion holes). Each of tip end surface 31a and tip end surface 31b is, for example, a flat surface intersecting the Z-axis direction. Tip end surface 31a and tip end surface 31b face in the same direction.

Tip end surface 31a is formed by second ferrule 312. Tip end surface 31a has, for example, a rectangular shape when viewed from the Z-axis direction. Tip end surface 31a protrudes from tip end surface 31b. Tip end surface 31a is located on the opposite side of rear end surface 21c with respect to tip end surface 31b. Tip end surface 31b is formed by second housing 311. Tip end surface 31b has, for example, a rectangular frame shape when viewed from the Z-axis direction. Tip end surface 31b surrounds end surface 31a when viewed from the Z-axis direction. Side surface 31d faces the outside of second housing 311 when viewed from the Z-axis direction.

Rear end surface 31c is formed by second housing 311 and second ferrule 312. Rear end surface 31c is, for example, a flat surface intersecting the Z-axis direction. Rear end surface 31c faces the opposite side to tip end surface 31a and tip end surface 31b. Side surface 31d is formed by second ferrule 312. Side surface 31d has, for example, a cylindrical shape extending along the Z-axis direction. Side surface 31d is located on the opposite side of rear end surface 31c with respect to tip end surface 31b. Side surface 31d surrounds tip end surface 31a when viewed from the Z-axis direction.

The plurality of insertion holes 31e are formed in second ferrule 312. Each insertion hole 31e extends along, for example, the Z-axis direction. Each insertion hole 31e has, for example, a cylindrical shape. In the embodiment, each insertion hole 31e penetrates second ferrule 312. That is, each insertion hole 31e is opened at each of tip end surface 31a and rear end surface 31c.

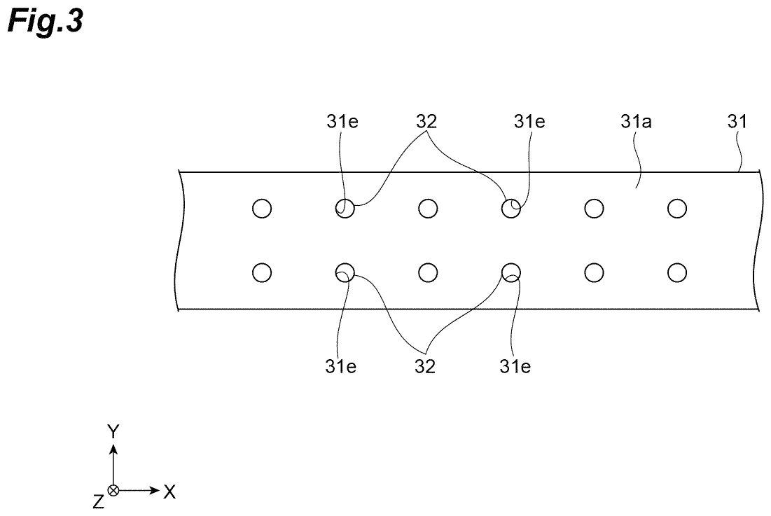

FIG. 3 is a front view of second connector 3. As shown in FIGS. 1 and 3, in the embodiment, second holding body 31 includes two rows of insertion holes 31e. Insertion holes 31e in the first row and insertion holes 31e in the second row are adjacent to each other in the Y-axis direction. Insertion holes 31e in each row are arranged along the X-axis direction.

Each second conductor 32 has, for example, a circular shape in a cross section along the XY plane. Each second conductor 32 is inserted into each insertion hole 31e. Thus, the plurality of second conductors 32 are held by second holding body 31. The material of second conductor 32 is, for example, a copper alloy.

First connector 2 is connected to second connector 3. Specifically, first connector 2 is fitted to second connector 3 such that tip end surface 21a of first holding body 21 faces tip end surface 31a of second holding body 31, tip end surface 21b of first holding body 21 faces tip end surface 31b of second holding body 31, and side surface 21d of first holding body 21 surrounds side surface 31d of second holding body 31. Side surface 21d and side surface 31d are in contact with each other. When first connector 2 is connected to second connector 3, first conductor 22 and second conductor 32 are brought into contact with each other. Thus, first conductor 22 and second conductor 32 are electrically connected to each other.

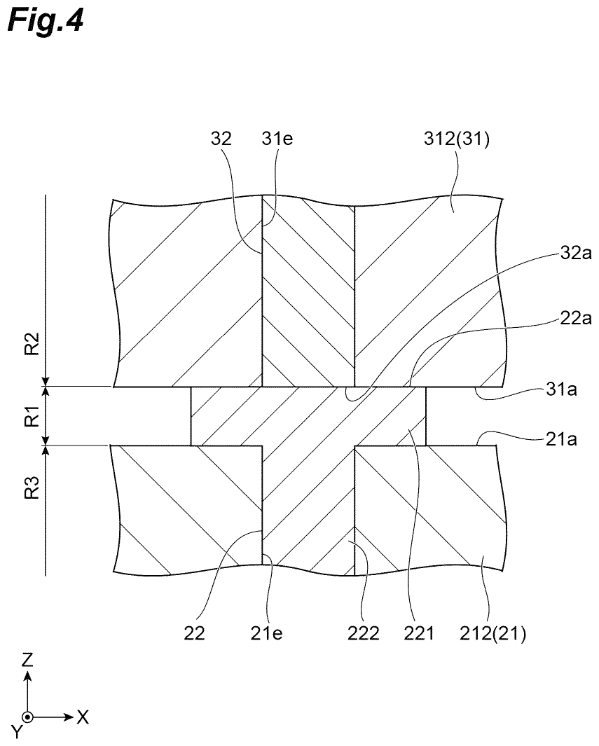

FIG. 4 is a partial enlarged view of FIG. 1. As shown in FIG. 4, first conductor 22 has a first tip end portion 221 and a first body portion 222. In the embodiment, first tip end portion 221 is a region of first conductor 22 located on the opposite side of rear end surface 21c with respect to tip end surface 21a. First tip end portion 221 protrudes from tip end surface 21a. First tip end portion 221 is located between tip end surface 21a and tip end surface 31a. First tip end portion 221 has, for example, a disk shape. First tip end portion 221 is formed by, for example, plastic deformation of the tip end of first conductor 22.

First tip end portion 221 includes a first connection surface 22a exposed from tip end surface 21a. First connection surface 22a is located on the opposite side of rear end surface 21c with respect to tip end surface 21a. First connection surface 22a is, for example, a flat surface intersecting the Z-axis direction. First connection surface 22a has, for example, a circular shape when viewed from the Z-axis direction.

In the embodiment, first body portion 222 is a region of first conductor 22 located on the opposite side of first tip end portion 221 with respect to tip end surface 21a. First body portion 222 is located on the opposite side of second connector 3 with respect to first tip end portion 221. First body portion 222 is disposed inside insertion hole 21e. First body portion 222 has, for example, a circular shape in a cross section along the XY plane. First tip end portion 221 and first body portion 222 are integrally formed of the same material. Each of first tip end portion 221 and first body portion 222 is a predetermined region of first conductor 22 which is one component.

The width of first connection surface 22a (the diameter of first connection surface 22a in the embodiment) when viewed from the Z-axis direction (the direction intersecting tip end surface 21a) is larger than the width of first body portion 222 (the diameter of first body portion 222 in the embodiment) when viewed from the direction intersecting the Z-axis direction. The width of first connection surface 22a is, for example, about 0.5 mm to 1.0 mm. The width of first body portion 222 is, for example, about 0.2 mm to 0.5 mm. The length (depth) of first tip end portion 221 is, for example, about 0.1 mm to 0.3 mm in the Z-axis direction.

Second conductor 32 includes a second connection surface 32a exposed from tip end surface 31a. Second connection surface 32a is, for example, a flat surface intersecting the Z-axis direction. In the embodiment, second connection surface 32a is flush with tip end surface 31a. Second connection surface 32a has, for example, a circular shape when viewed from the Z-axis direction (direction intersecting end surface 31a). Second connection surface 32a faces first connection surface 22a. When viewed from the Z-axis direction, the width of first connection surface 22a is larger than the width of second connection surface 32a (the diameter of second connection surface 32a in the embodiment). In the embodiment, the width of second connection surface 32a is the same as the width of first body portion 222. In the embodiment, the width of second conductor 32 (the diameter of second conductor 32 in the embodiment) is the same as the width of first body portion 222. The width of second connection surface 32a (the width of second conductors 32) is, for example, about 0.2 mm to 0.5 mm.

First tip end portion 221 is surrounded by a first region R1 of first holding body 21. First region R1 is a region of first holding body 21 that surrounds first tip end portion 221 when viewed from the Z-axis direction and overlaps first tip end portion 221 when viewed from the direction along the XY plane. In the embodiment, first region R1 is a region between tip end surface 21a and first connection surface 22a of first tip end portion 221. In the embodiment, first region R1 contains air. In the embodiment, first region R1 is filled with air.

Second conductor 32 is surrounded by a second region R2 of second holding body 31. Second region R2 is a region of second holding body 31 that surrounds second conductor 32 when viewed from the Z-axis direction and overlaps second conductor 32 when viewed from a direction along the XY plane. In the embodiment, second region R2 is a region between tip end surface 31a and rear end surface 31c. In the embodiment, second region R2 is formed by second ferrule 312.

First body portion 222 is surrounded by a third region R3 of first holding body 21. Third region R3 is a region of first holding body 21 that surrounds first body portion 222 when viewed from the Z-axis direction and overlaps first body portion 222 when viewed from the direction along the XY plane. In the embodiment, third region R3 is a region between tip end surface 21a and rear end surface 21c. In the embodiment, third region R3 is formed by first ferrule 212.

The dielectric constant of first region R1 is smaller than the dielectric constant of each of second region R2 and third region R3. In the embodiment, the dielectric constant of second region R2 is the same as the dielectric constant of third region R3. The dielectric constant of first region R1 is, for example, about 1.0 to 2.0. In the embodiment, the dielectric constant of first region R1 is about 1.0. The dielectric constant of second region R2 is, for example, about 1.5 to 5.0. The dielectric constant of third region R3 is, for example, about 1.5 to 5.0. In the embodiment, the dielectric constant refers to a relative dielectric constant.

As described above, in connector system 1, the width of first connection surface 22a is larger than the width of second connection surface 32a. Thus, even if the position of first conductor 22 and the position of second conductor 32 are misaligned (for example, even if the center line of first conductor 22 and the center line of second conductor 32 are misaligned each other), the contact area between first conductor 22 and second conductor 32 is ensured, and as a result, the conduction between first conductor 22 and second conductor 32 is ensured. In addition, the dielectric constant of first region R1 surrounding first tip end portion 221 of first holding body 21 is smaller than the dielectric constant of second region R2 surrounding second conductor 32 of second holding body 31. Thus, the impedance disturbance around first tip end portion 221 and second conductor 32 is prevented, and as a result, a deterioration in communication performance is prevented. According to connector system 1, it is possible to prevent a deterioration in communication performance while ensuring conduction.

The width of first connection surface 22a when viewed from the Z-axis direction is larger than the width of first body portion 222 when viewed from the Z-axis direction. The dielectric constant of first region R1 is smaller than the dielectric constant of third region R3 surrounding first body portion 222 of first holding body 21. Thus, the contact area between first conductor 22 and second conductor 32 is ensured, and the impedance disturbance around first conductor 22 is prevented.

First region R1 contains air. Each of second region R2 and third region R3 contains a resin. Thus, the impedance disturbance around first conductor 22 and second conductor 32 is prevented in a preferred manner.

First tip end portion 221 is integrally formed with first body portion 222. Thus, the number of components of connector system 1 is reduced.

First holding body 21 includes the plurality of insertion holes 21e opening at tip end surface 21a. First conductor 22 is each of a plurality of electric wires of the flexible flat cable. Each first conductor 22 is inserted into each insertion hole 21e. Thus, the electrical connection of the electric wires of the flexible flat cable is ensured, and the deterioration of the communication performance of the flexible flat cable is prevented.

Second holding body 31 includes the plurality of insertion holes 31e opening at end surface 31a. Each second conductor 32 is inserted into each insertion hole 31e. Thus, the electrical connection of the electric wires of the flexible flat cable is ensured, and the deterioration of the communication performance of the flexible flat cable is prevented.

### MODIFICATION

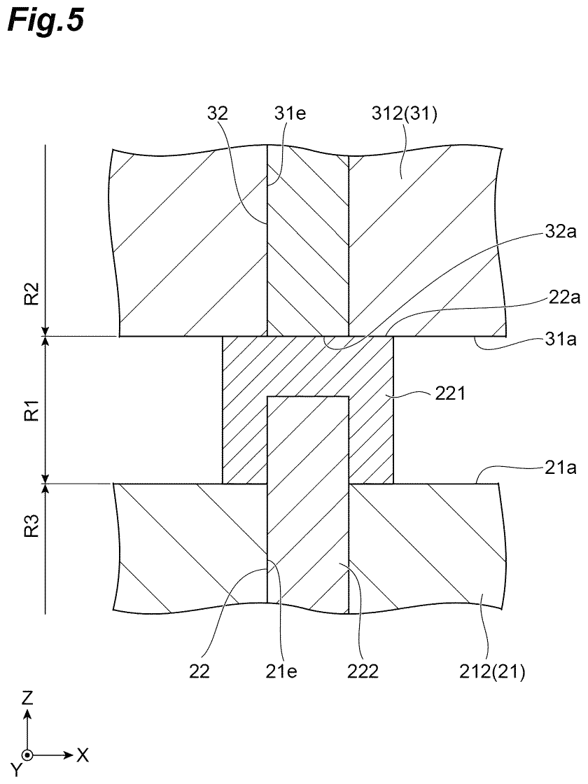

FIG. 5 is a cross-sectional view of a connector system according to a first modification. As shown in FIG. 5, first tip end portion 221 of first conductor 22 may be formed separately from first body portion 222 of first conductor 22. Specifically, a part of first body portion 222 protrudes from end surface 21a. First tip end portion 221 may be a lid member provided at the tip end of first body portion 222. First tip end portion 221 has, for example, a tubular shape. One end of first tip end portion 221 is opened, and the other end of first tip end portion 221 is closed. First connection surface 22a is formed by an outer surface of the closing wall of first tip end portion 221. First tip end portion 221 may be, for example, a solder material or the like formed at the tip end of first body portion 222. The material of first tip end portion 221 may be different from the material of first body portion 222. According to such a configuration, the design flexibility of each of first tip end portion 221 and first body portion 222 is improved.

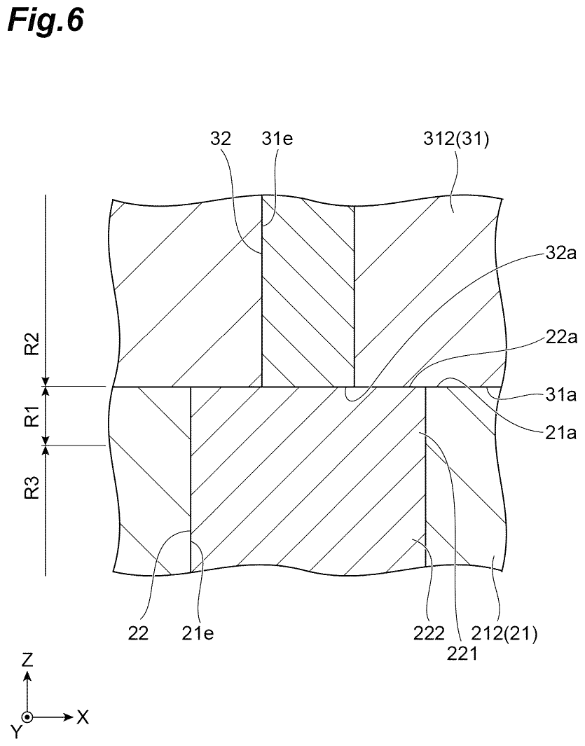

FIG. 6 is a cross-sectional view of a connector system according to a second modification. As shown in FIG. 6, the width of first body portion 222 of first conductor 22 may be the same as the width of first tip end portion 221 of first conductor 22. In this case, first connection surface 22a may be flush with end surface 21a. In this case, the dielectric constant of third region R3 may be the same as the dielectric constant of first region R1. The dielectric constant of each of first region R1 and third region R3 may be of second region R2. First region R1 may be formed by first ferrule 212, similarly to third region R3. First region R1 may be formed integrally with third region R3 by using the same material.

In the embodiment, first connector 2 is a plug connector and second connector 3 is a receptor connector, but first connector 2 may be a receptor connector and second connector 3 may be a plug connector. In this case, second conductor 32 may be each of the plurality of electric wires of the flexible flat cable.

In the embodiment, first region R1 is filled with air, but first region R1 may contain, for example, a dielectric constant adjusting agent or the like. First region R1 may be filled with the dielectric constant adjusting agent or the like. The dielectric constant adjusting agent includes a material such as rubber. The dielectric constant of first region R1 may be smaller than the dielectric constant of second region R2.

In the embodiment, each insertion hole 21e has a cylindrical shape, and first conductor 22 has a circular shape in the cross section along the XY plane. However, insertion hole 21e may have, for example, a rectangular cylindrical shape, and first conductor 22 may have, for example, a rectangular shape in the cross section along the XY plane. In the embodiment, each insertion hole 31e has a cylindrical shape, and second conductor 32 has a circular shape in the cross section along the XY plane. However, insertion hole 31e may have, for example, a rectangular cylindrical shape, and second conductor 32 may have, for example, a rectangular shape in the cross section along the XY plane.

In the embodiment, first holding body 21 includes insertion holes 21e in two rows, but first holding body 21 may include insertion holes 21e in one row or three or more rows, for example. In the embodiment, second holding body 31 includes insertion holes 31e in two rows, but second holding body 31 may include insertion holes 31e in one row or three or more rows, for example.

In the embodiment, first holding body 21 includes first housing 211 and first ferrule 212, but first holding body 21 may be formed of one component. In this case, the material of first holding body 21 may be the same as the material of first ferrule 212. In the embodiment, second holding body 31 includes second housing 311 and second ferrule 312, but second holding body 31 may be formed of one component. In this case, the material of second holding body 31 may be the same as the material of second ferrule 312.

In the embodiment, the width of second conductor 32 is the same as the width of first body portion 222 of first conductor 22, but the width of second conductor 32 may be different from the width of first body portion 222. In this case, the dielectric constant of second region R2 may be different from the dielectric constant of third region R3.

In the embodiment, first conductor 22 is inserted into insertion hole 21e of first ferrule 212, but first conductor 22 may be held by a mold filled in first housing 211. In the embodiment, second conductor 32 is inserted into insertion hole 31e of second ferrule 312, but second conductor 32 may be held by a mold filled in second housing 311.

What is claimed is:

1. A connector system comprising:
a first connector including a first holding body having a first tip end surface, and a first conductor held by the first holding body; and
a second connector including a second holding body having a second tip end surface configured to face the first tip end surface, and a second conductor held by the second holding body,
wherein the first conductor includes a first tip end portion having a first connection surface exposed at the first tip end surface, and a first body portion located on a side of the first tip end portion opposite to a side where the second connector is present,
wherein the second conductor has a second connection surface exposed at the second tip end surface and configuring to face the first connection surface,
wherein a width of the first connection surface viewed in a direction intersecting the first tip end surface is larger than a width of the second connection surface viewed in a direction intersecting the second tip end surface, and
wherein a dielectric constant of a first region of the first holding body, the first region surrounding the first tip end portion, is smaller than a dielectric constant of a second region of the second holding body, the second region surrounding the second conductor.

2. The connector system according to claim 1,
wherein the width of the first connection surface is larger than a width of the first body portion viewed in the direction intersecting the first tip end surface, and
wherein the dielectric constant of the first region is smaller than a dielectric constant of a third region of the first holding body, the third region surrounding the first body portion.

3. The connector system according to claim 2,
wherein the first region contains air, and
wherein each of the second region and the third region contains a resin.

4. The connector system according to claim 1,
wherein the first tip end portion is formed to be integrated with the first body portion.

5. The connector system according to claim 1,
wherein the first tip end portion is formed to be separated from the first body portion.

6. The connector system according to claim 1,
wherein the first holding body has a plurality of first insertion holes opening at the first tip end surface,
wherein the first conductor is each of a plurality of electrical wires of a flexible flat cable, and
wherein each of the plurality of electrical wires is inserted into a corresponding one of the plurality of first insertion holes.

7. The connector system according to claim 6,
wherein the second holding body has a plurality of second insertion holes opening at the second tip end surface,
wherein the second conductor is each of a plurality of conductors, and
wherein each of the plurality of conductors is inserted into a corresponding one of the plurality of second insertion holes.

8. A connector system comprising:
a first connector including a first holding body having a first tip end surface, and a first conductor held by the first holding body, first conductor including a first tip end portion having a first connection surface and a first body portion located within the first holding body; and
a second connector including a second holding body having a second tip end surface, and a second conductor held by the second holding body, the second conductor including a second connection surface,
wherein a width of the first connection surface is larger than a width of the second connection surface, and
wherein the first tip end portion is surrounded by at least one of air, a dielectric constant adjusting agent or low dielectric constant material, the low dielectric constant material having a smaller dielectric constant than that of the second holding body.

9. The connector system according to claim 8,
wherein the first tip end portion protrudes from the first tip end surface.

10. The connector system according to claim 8,
wherein the first tip end portion is partially located on the first tip end surface.

11. The connector system according to claim 8,
wherein the first tip end portion has a depth between 0.1 mm and 0.3 mm.

12. The connector system according to claim 8,
wherein the first tip end portion is surrounded by the air.

13. The connector system according to claim 8,
wherein the first holding body includes a first ferrule holding the first conductor and a first housing disposing the first ferrule thereinside,
wherein the first ferrule has a first ferrule tip end surface and the first housing has a first housing tip end surface, the first ferrule tip end surface being depressed from the first housing tip end surface.

14. The connector system according to claim 13,
wherein the second holding body includes a second ferrule holding the second conductor and a second housing disposing the second ferrule thereinside,
wherein the second ferrule has a second ferrule tip end surface and the second housing has a second housing tip end surface, the second ferrule tip end surface being protruded from the second housing tip end surface and located inside the first housing.

15. The connector system according to claim 14,
wherein the first connector is a plug connector, and the second connector is a receptor connector.

16. A connector comprising:
a holding body having a tip end surface and a rear end surface opposite to the tip end surface; and
a conductor held by the holding body,
wherein the conductor includes a tip end portion having a connection surface exposed at the tip end surface, and a body portion located on a side of the tip end portion closer to the rear end surface,
wherein a width of the connection surface viewed in a direction intersecting the tip end surface is larger than a width of the body portion viewed in the direction intersecting the tip end surface, and
wherein a dielectric constant of a region of the holding body, the region surrounding the tip end portion, is smaller than a dielectric constant of another region of the holding body, the other region surrounding the body portion.

17. The connector according to claim 16,
wherein the tip end portion is surrounded by at least one of air, a dielectric constant adjusting agent or low dielectric constant material, the low dielectric constant material having a smaller dielectric constant than that of a mating connector.

18. The connector according to claim 16,
wherein the tip end portion protrudes from the tip end surface.
